(19) United States
(12) Patent Application Publication
(10) Pub. No.: US 2020/0041303 A1
(43) Pub. Date: Feb. 6, 2020

(54) METHOD AND APPARATUS FOR WEATHER SUPPORT FOR AN AUTONOMOUS VEHICLE

(71) Applicant: TOYOTA MOTOR ENGINEERING & MANUFACTURING NORTH AMERICA, INC., Plano, TX (US)

(72) Inventors: Scott A. FRIEDMAN, Dallas, TX (US); Prince Remegio, Lewisville, TX (US); Tim Uwe Falkenmayer, Mountain View, CA (US); Roger Akira Kyle, Lewisville, TX (US); Ryoma Kakimi, Ann Arbor, MI (US); Luke D. Heide, Plymouth, MI (US); Nishikant Narayan Puranik, Frisco, TX (US)

(73) Assignee: TOYOTA MOTOR ENGINEERING & MANUFACTURING NORTH AMERICA, INC., Plano, TX (US)

(21) Appl. No.: 16/056,107

(22) Filed: Aug. 6, 2018

(51) Int. Cl. G01C 21/36; G01C 21/34; G05D 1/00

(52) U.S. Cl. CPC G01C 21/3691; G01C 21/3492; G05D 2201/0213; G01C 21/3697; G05D 1/0088; G01C 21/3608

(57) ABSTRACT

A method and an apparatus for weather support are provided. In an embodiment, a request from a user to check weather information is received, and trip information provided by the request is also identified. The weather information in response to the request is retrieved and output to the user. In another embodiment, user information of the user and the trip information of the trip are captured. The weather information corresponding to the trip is retrieved and output to the user. In addition, trip suggestions are provided to the user. In yet another embodiment, the trip information is retrieved and available routes are identified corresponding to the trip. Further, respective weather information, respective traffic information, and respective physical information of each of the available routes are retrieved. Route for the trip is determined based on the respective weather information, the respective physical information and the respective traffic information of each of the available routes.

### BACKGROUND

Obtaining weather information in a driving environment accurately and promptly is generally important to a driver or a passenger. Obtaining weather information to avoid a weather hazard when deploying self-driving technology is also important. Systems and methods for weather support have been studied in, for example, U.S. Patent Application Publication No. 20170043789 A1 entitled “Personal Vehicle Management” and directed to a method for determining a route of the vehicle based upon a trip library and/or current location. The trip library includes a weather characteristic of the route.

The foregoing “Background” description is for the purpose of generally presenting the context of the disclosure. Work of the inventors, to the extent it is described in this background section, as well as aspects of the description which may not otherwise qualify as prior art at the time of filing, are neither expressly or impliedly admitted as prior art against the present invention.

### SUMMARY

The present disclosure relates to a method, an apparatus, and a computer-readable medium configured to provide weather information to a user of a vehicle, provide trip suggestions according to the weather information, and provide route selections based on the weather information so as to avoid a weather hazard. The user of the vehicle can be a driver or a passenger. The weather information disclosed herein can include rain, snow, ice, fog, heat, a flood, a tornado, a hurricane, an earthquake, a hail storm, a high wind, or the like. The present disclosure targets both a regular vehicle that needs a driver and an autonomous vehicle that drives autonomously or automatically. According to an embodiment of the present disclosure, a request from the user, via interface circuitry of the apparatus, is received to check the weather information. Once the request is received, expected location and expected time are identified by the processing circuitry of the apparatus. The expected location and expected time are provided by the request. Accordingly, the weather information corresponding to the request is retrieved and output to the user in response to the request.

In an embodiment, the request is received via a microphone. The expected location and the expected time provided by the request are identified through voice recognition techniques. The weather information in response to the request is retrieved through a weather website, an application, and/or a data store. The weather information is output through a speaker or a display device in response to the request. Trip suggestions are also provided according to the weather information via the speaker or the display device. The trip suggestions include suggestions on trip supplies and suggestions on trip safety.

In an embodiment, the retrieving the weather information in response to the request includes retrieving the weather information on a specific day or at specific time, retrieving the weather information for a duration of days or a period of time, retrieving the weather information for a specific location, and retrieving current weather information at current location.

In an embodiment, user information can be captured through a camera. The user information includes trip supplies (e.g., an umbrella, a pair of rain boots) that the user prepares for the trip. The user information can also include dress (e.g., a heavy jacket, a pair of gloves) that the user wears. In addition, trip information is captured through a navigation system installed in the vehicle, a portable communication device of the user (e.g., a smartphone or a tablet), or the request input via a microphone by the user. The trip information includes an expected location (e.g., a departure location, a transition location, and a destination) of the trip and expected time (e.g., departure time, transition time, arrival time) of the trip. Subsequently, the weather information associated with the trip (e.g., an expected location, expected time) is captured through a weather website, an application, and/or a data store. The weather information corresponding to the trip is output to the user through the speaker or the display device. The trip suggestions are also provided regarding the trip supplies and trip safety through the speaker or the display device based on the captured user information, the captured trip information and the retrieved weather information. For example, the user can be reminded to bring an umbrella when rain is expected at the destination.

In an embodiment, the capturing the user information of the user is operated through image recognition, pattern recognition, feature recognition, signal recognition, or any other suitable technologies. In another embodiment, a machine learning algorithm is trained based on the captured user information, and the trained machine learning algorithm is deployed to identify similar user information in a future event accurately and promptly.

In an embodiment, the trip information (e.g. the expected locations and the expected time) of the trip are retrieved through the navigation system installed in the vehicle, the portable communication device of the user, or the request input via a microphone by the user. Next, available routes associated with the trip are identified through a map database. Subsequently, weather information of the available routes is retrieved through the weather website, the application, and/or the data store. In addition, physical information of the available routes is retrieved through a vehicle to infrastructure system, a cloud-based system, an application, and/or a data store. Traffic information of the available routes is acquired through a traffic system, a cloud-based system, an application, and/or a data store. Route for the trip is determined based on the weather information, the physical information and traffic information of the available routes. The route for the trip is output to the speaker, the display device, and/or the navigation system.

The physical information of the routes includes a road repair, total lanes, road surface conditions, an on-ramp, an off-ramp, an incline, a decline, a curve, a straightaway, a pothole, or the like. The traffic information of the routes includes traffic congestion, a stop sign, a speed limit, traffic lights, or the like.

In an embodiment, among the available routes, routes having no weather hazard (e.g., snow, a heavy wind, a hurricane) or least weather hazard are selected firstly based on the weather information associated with the routes. Next, routes having no traffic issues (e.g., traffic jam, traffic accidents) or fewest traffic issues are selected from the routes that have no weather hazard or least weather hazard based on the traffic information of the routes. Further, routes having no physical issues (e.g., rough road surface, potholes) or fewest physical issues are selected from the routes that have no traffic issues or fewest traffic issues based on the physical information of the routes. The route for the trip is determined from the routes that have no physical issues or fewest physical issues based on total driving time, driving costs, or driving distance.

In an embodiment, the determined route for the trip is output to the navigation system and driving of the vehicle is automatically controlled through a control unit according to the determined route that is output to the navigation system.

In another embodiment, the apparatus for weather support is disclosed. The apparatus includes an interface group and a processing group. The interface group includes a camera configured to capture the user information, an audio input device configured to receive the request for checking the weather information, an audio output device configured to output the weather information or the trip suggestions, a communication device configured to acquire the weather information and trip information (e.g., an expected location, expected time), a display device configured to display the weather information or the trip suggestions.

The processing group includes an interface device configured to transmit messages within the apparatus and between the apparatus and external devices, a processing device configured to implement the method for weather support that is mentioned above, a training device configured to train the machine learning algorithm, a map database configured to provide route information, a driving database configured to provide reference information associated with drivers, passengers, traffic conditions, and road conditions, and a program database configured to store programs. The programs when executed by processing circuitry cause the processing circuitry to perform operations for weather support. In another embodiment, the apparatus can further includes sensors configured to sense surrounding traffic information for the autonomous vehicle during driving, the driving control unit configured to control the driving of the vehicle automatically, and the navigation system configured to provide navigation service.

In yet another embodiment, a non-transitory computer readable storage medium having instructions stored thereon that when executed by processing circuitry causes the processing circuitry to perform operations for weather support that is mentioned above.

In the present disclosure, the method and the apparatus provide expanded weather support to the user of the vehicle and enhance interaction between the user and the vehicle. The method and the apparatus can passively receive the request from the user to check the weather information, and provide the weather information corresponding to the expected location and the expected time provided by the request. The method and the apparatus can further provide trip suggestions based on the weather information to the user. The method and the apparatus can also proactively capture the user information and trip information of the user. The user information includes trip supplies that the user prepares for the trip and the dress that the user wears. The method and the apparatus proactively retrieve the weather information associated with the trip and provide the weather information and trip suggestions to the user. The trip suggestions can be suggestions on the trip supplies and the trip safety. The method and the apparatus can further provide route selections based on the weather information and the trip information so as to avoid weather hazard. The method and the apparatus can implement machine learning to improve the interaction between the user and the vehicle. In the present disclosure, the machine learning algorithm is trained based on the captured user information, and the trained machine learning algorithm is deployed to identify the similar user information in a future event accurately and promptly.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is an illustration of an exemplary apparatus for weather support, in accordance with some embodiments.

FIG. 2 is a flowchart outlining a first exemplary operation for weather support, in accordance with some embodiments.

FIG. 3 is a flowchart outlining a second exemplary operation for weather support, in accordance with some embodiments.

FIG. 4 is a schematic diagram illustrating an exemplary machine learning process, in accordance with some embodiments.

FIG. 5 is a flowchart outlining a third exemplary operation for weather support, in accordance with some embodiments.

FIG. 6 is a flowchart outlining a fourth exemplary operation for weather support, in accordance with some embodiments.

FIG. 7 is an illustration of another exemplary apparatus for weather support, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

Obtaining weather information in a driving environment accurately and promptly is important to a driver or a passenger of a vehicle. Obtaining the weather information to avoid weather hazard is also required when deploying self-driving technology. In the current disclosure, a method, an apparatus, and a computer-readable medium are disclosed to provide the weather information to a user (e.g., a driver, a passenger) of the vehicle, give trip suggestions according to the weather information, and provide route selections based on the weather information so as to avoid weather hazard.

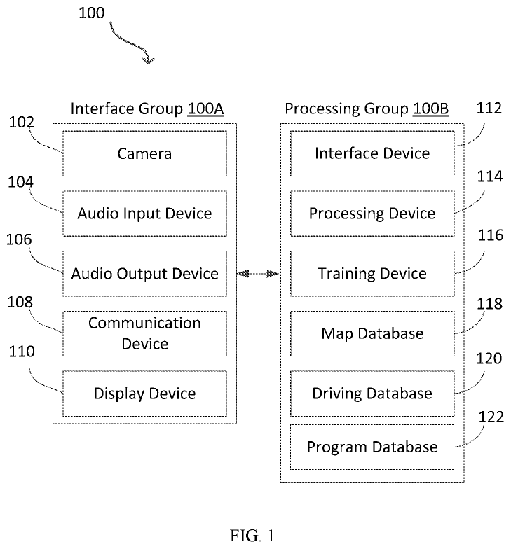

FIG. 1 is an illustration of an exemplary apparatus 100 for weather support. The apparatus 100 can include an interface group 100A and a processing group 100B. The interface group 100A can include a camera 102, an audio input device 104, an audio output device 106, a communication device 108, and a display device 110, or the like. The camera 102 can be a visible light camera or an infrared camera. The camera 102 can be configured to capture visual data of the vehicle interior and/or the vehicle exterior. When the user enters the vehicle, the camera 102 can acquire at least an image from the user. The image can include dress (e.g., a heavy jacket, a pair of gloves) of the user, luggage of the user, trip supplies (e.g., a boot, an umbrella), or the like. The image acquired by the camera 102 can be sent to the processing group 100B for visual data processing. The visual data processing can be implemented by signal processing, imaging processing, or video processing through a processing device 114 of the apparatus 100. Upon completion of the visual data processing, the apparatus 100 can detect whether the user is prepared for future weather that may be encountered. For example, the apparatus 100 can detect that the user does not carry an umbrella or does not wear rain boots. In an embodiment illustrated in FIG. 1, the camera 102 is a visible light camera and the image acquired by the camera 102 can be used for weather support. The camera can be mounted on front, rear, top, sides, and interior of the vehicle depending on the technology requirement.

The audio input device 104 disclosed in FIG. 1 is configured to receive an audio signal and convert the audio signal into an electrical signal. The converted electrical signal is further sent to the processing device 114 for signal processing. In an embodiment of FIG. 1, the audio input device can be a microphone. In an example of the current disclosure, the user can send an audio request to check the weather information through the microphone. When the audio request is received by the microphone 114, the microphone 114 converts the audio request into an electrical signal, and sends the electrical signal to the processing device 114 for signal processing. Upon completion of the signal processing on the electrical signal, the apparatus 100 can identify the expected location and the expected time provided by the request. The apparatus 100 can further retrieve the weather information corresponding to the expected location and the expected time, and provide the weather information to the user.

The audio output device 106 illustrated in FIG. 1 is configured to turn an electrical signal into an audio signal. In an embodiment of FIG. 1, the audio output device 106 is a speaker. Once the apparatus 100 retrieves the weather information corresponding to the expected location and the expected time provided by the request, the apparatus 100 can output an electrical signal carrying the weather information to the speaker 106, and the speaker 106 subsequently converts the electrical signal into an audio signal/message and provides the audio signal/message to the user.

The communication device 108 can be configured to communicate with any suitable device using any suitable communication technologies, such as wired, wireless, fiber optic communication technologies, and any suitable combination thereof. In an example, the communication device 108 can be used to communicate with other vehicles in vehicle to vehicle (V2V) communication, and with an infrastructure, such as a cloud services platform, in vehicle to infrastructure (V2I) communication. In an embodiment, the communication device 108 can include any suitable communication devices using any suitable communication technologies. In an example, the communication device 108 can use wireless technologies, such as IEEE 802.15.1 or Bluetooth, IEEE 802.11 or Wi-Fi, mobile network technologies including such as global system for mobile communication (GSM), universal mobile telecommunications system (UMTS), long-term evolution (LTE), fifth generation mobile network technology (5G) including ultra-reliable and low latency communication (URLLC), and the like. In an embodiment of FIG. 1, the communication device 108 is configured to retrieve the weather information from a weather website, an application, and/or a data store. The communication device 108 can also remotely connect to a portable communication device (e.g., a smart phone, or a tablet) of the user to access the trip information of the user, such as the expected location (e.g., a departure location, a transition location, or a destination) and the expected time (departure time, transition time, or arrival time) of the trip. In another embodiment of FIG. 1, the communication device 108 can retrieve the trip information (e.g., the expected location, the expected time) from a navigation system (not shown in FIG. 1) in the vehicle. The communication device 108 can further access a traffic website, an application, and/or a data store to update map database 118 or retrieve the traffic information of a route. In another application, the communication device 108 can retrieve physical information of the route through a vehicle to infrastructure system, a cloud-based system, an application, and/or a data store.

The display device 110 is configured to display the weather information or trip suggestions that are sent from the processing device 114. The display device 110 can receive electrical signals carrying the weather information or the trip suggestions that is sent from the processing device 114 and convert the electrical signals into text messages, images, or videos. The display device 110 can be a cathode ray tube display (CRT), a light-emitting diode display (LED), an electroluminescent display (ELD), a liquid crystal display (LCD), an organic light-emitting diode display (OLED), or the like. In another embodiment, the display device 110 can be a touchscreen that displays the weather information, the trip suggestions, and receives the request typed in by the user.

In an embodiment, the processing group 100B can be a well-known microcomputer or a processor having CPU (central processing unit), ROM (read only memory), RAM (random access memory) and I/O (input and output) interface. The processing group 100B can realize various functions by reading programs stored in program database 122 of the processing group 100B. In another embodiment, the processing group 100B is not necessarily constituted by a single processor but may be constituted by a plurality of devices. For example, some or all of these functions may be realized by an application specific integrated circuit (ASIC), a field programmable gate array (FPGA), a digital signal processor (DSP), or the like. As shown in FIG. 1, the processing unit 100B can include an interface device 112, a processing device 114, a training device 116, a map database 118, a driving database 120, a program database 122, or the like.

The map database 118 is configured to provide route/map information. The driving database 120 is configured to provide reference information associated with drivers, passengers, traffic conditions, and road conditions. For example, the driving database 120 can include a reference image of umbrella, or a reference image of rain boots. The driving database 120 can also include a reference image of a pothole, a speed hump, or the like. The program database 122 is configured to store programs. The programs can implement various functions of the apparatus 100 when executed by the processing device 114. The program database 122 can also include a machine learning algorithm that can be trained and deployed to the processing device 114 for weather support.

The interface device 112 is configured to transmit messages within the apparatus 100, and between the apparatus 100 and external devices. For example, the interface device 112 can continuously, or periodically, or as occasion demands acquire messages from the interface group 100A, such as from the camera 102, the audio input device 106, the communication device 108, or the display device 110. Once the interface device 112 acquires the messages from the interface group 100A, the interface device 112 sends the messages to the processing device 114 for analysis. The interface device 112 can send messages generated by the processing device 114 within the apparatus 100, such as sending the messages to the audio output device 106 or the display device 110. The interface device 112 can also send the messages generated by the processing device 114 to external devices, such as a driving control unit (not shown in FIG. 1), or a navigation system (not shown in FIG. 1).

The processing device 114 is configured to analyze the messages acquired by the interface group 100A and send output of the analysis to the interface group 100A or external devices (e.g., the driving control unit, the navigation system) via the interface device 112. In an example, the user sends a request to check the weather information through the microphone 104. The request is acquired by the processing device 114 via the interface device 112. The processing device 114 identifies the expected location (e.g., a departure location, a transition location, or a destination) and the expected time (e.g., departure time, transition time, or arrival time) that are provided by the request through the voice recognition techniques. The processing device 114 subsequently sends an instruction to the communication device 108 via the interface device 112 to retrieve the weather information in response to the request. The communication device 108 retrieves the weather information through a weather website, an application, and/or a data store and sends the weather information to the processing device 114 via the interface device 112. The processing device 114 further outputs the weather information to the user through either the speaker 106 or the display device 110 via the interface device 112.

In another example, the camera 102 proactively captures user information when the user enters the vehicle. The user information includes trip supplies that the user prepares for the trip. The user information also includes dress that the user wears. The camera 102 sends the user information to the processing device 114 via the interface device 112. In addition, the communication device 108 can proactively acquire trip information of the user through a navigation system installed in the vehicle, a portable communication device of the user, or the request input via a microphone by the user. The trip information includes the expected location (e.g. a departure location, a transition location, and a destination) of the trip and the expected time (e.g. departure time, transition time, arrival time) of the trip. The communication device 108 further sends the trip information to the processing device 114 via the interface device 112. The processing device 114 firstly processes the user information captured by the camera 102 through signal processing, image processing, or video processing to identify the trip supplies that the user carries and the dress that the user wears. In addition, the processing device 114 analyzes the trip information captured by the communication device 108 to identify the expected location and the expected time of the trip. The processing device 114 further retrieves the weather information through the communication device 108 according to the trip information. In an embodiment, the processing device 114 recognizes that the destination of the trip has rain based on the trip/weather information and the user does not have an umbrella based on the user information. The processing device 114 therefore outputs the weather information corresponding to the trip through the speaker 104 and/or the display device 110. The processing device 114 can further send trip suggestions to remind that the user needs the umbrella via the speaker 104 and/or the display device 110.

In yet another embodiment, the communication device 108 can proactively acquire the trip information of the user through the navigation system installed in the vehicle, the portable communication device of the user, or the request input via a microphone by the user. The trip information includes an expected location (e.g. a departure location, a transition location, and a destination) of the trip and expected time (e.g. departure time, transition time, arrival time) of the trip. The communication device 108 further sends the trip information to the processing device 114 via the interface device 112. The processing device 114 processes the trip information sent by the communication device 108 and identifies the departure location and the destination based on the trip information. The processing device 114 further acquires available routes corresponding to the trip from the map database 118. The available routes can include one or more routes connecting the departure location and the destination. The processing device 114 then retrieves respective weather information of each of the available routes through a weather website, an application, and/or a data store. The processing device 114 also retrieves respective physical information of each of the available routes through a vehicle to infrastructure system, a cloud-based system, an application, and/or a data store. The processing device 114 further retrieves the specific traffic information of each of the available routes through at least one of a traffic system, a cloud-based system, an application, and/or a data store.

Once the weather information, the traffic information, and the physical information of the available routes are collected, the processing device 114 starts to determine route for the trip. The processing device 114 firstly selects routes having no weather hazard (e.g., snow, a heavy wind, a hurricane) or least weather hazard from the available routes based on the respective weather information of each of the available routes. Next, the processing device 114 selects routes having no traffic issues or fewest traffic issues from the routes that have no weather hazard or least weather hazard based on the respective traffic information of each of the available routes. The processing device 114 further selecting routes having no physical issues or fewest physical issues from the routes that have no traffic issues or fewest traffic issues based on the respective physical information of each of the available routes. The processing device 114 then determines the route for the trip from the routes that has no physical issues or fewest physical issues based on criteria, such as total driving time, driving costs, or driving distance. The processing device 114 can output the determined route for the trip to the display device 110 or the navigation system.

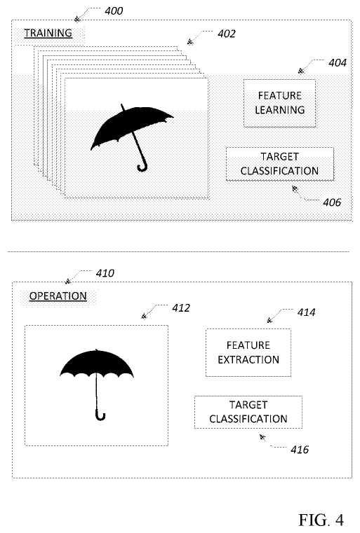

Still referring to FIG. 1, the training device 116 can receive the user information output by the processing device 114. The training device 116 can also retrieve the machine learning algorithm from the program database 122 to train the machine learning algorithm based on the received user information. The machine learning algorithm training process can be illustrated in FIG. 4. Once the machine learning algorithm is trained, the training device 116 can deploy the machine learning algorithm to the processing device 114. The processing device 114 can further detect similar user information through the trained machine learning algorithm accurately and promptly in a future event.

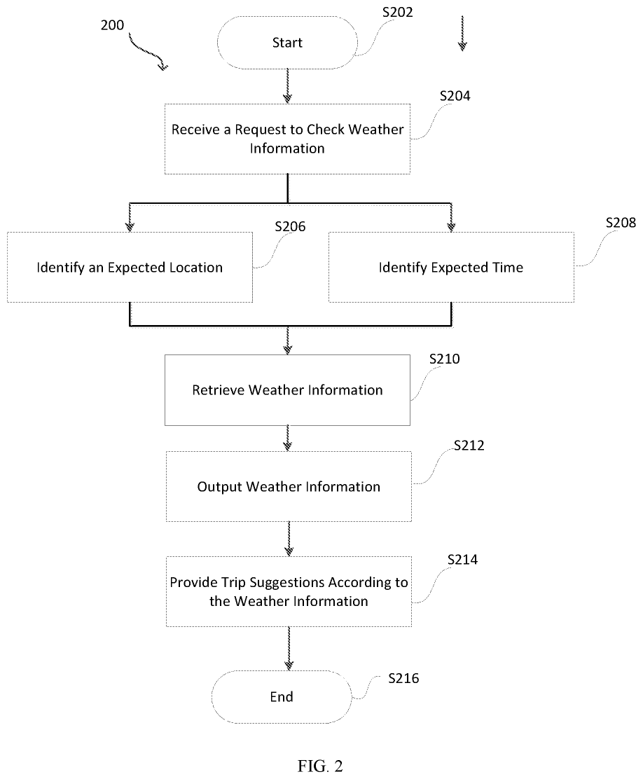

FIG. 2 illustrates a flowchart 200 outlining a first exemplary operation 200 for weather support in accordance with some embodiments of apparatus 100. The flowchart 200 starts with step 202 where the apparatus 100 for weather support is operated by a vehicle. At step 204, the user sends a request to check the weather information through the audio input device 104 (e.g., a microphone). For example, the user may ask “what will the weather be like on Tuesday between 9 am and 3 pm? I have an appointment.” The request is acquired by the processing device 114 via the interface device 112. At step 206 and step 208, the processing device 114 identifies the expected location (e.g., a departure location, a transition location, or a destination) and the expected time (e.g., departure time, transition time, or arrival time) that are provided by the request respectively through a voice recognition technique. According to the example provided above, the expected location may be the destination, and the expected time is Tuesday between 9 am and 3 pm. At step 210, the processing device 114 subsequently sends an instruction to the communication device 108 via the interface device 112 to retrieve the weather information according to the request. The communication device 108 retrieves the weather information in response to the request through a weather website, an application, and/or a data store and sends the weather information to the processing device 114 via the interface device 112. At step 212, the processing device 114 outputs the weather information to the user through either the audio output device 106 (e.g., a speaker) or the display device 110 via the interface device 112. At step 214, the processing device 114 can further provide trip suggestions based on the retrieved weather information through the speaker 106 or the display device 110. For example, the processing device 114 can remind the user to bring an umbrella or wear rain boots when the expected location has rain at the expected time.

In an embodiment of the operation 200 illustrated in FIG. 2, at step 210, the apparatus 100 can retrieve weather information on a specific day or at specific time. The apparatus 100 can also retrieve weather information for a duration of days or a period of time. The apparatus 100 can further retrieve weather information for a specific location or retrieve current weather at current location.

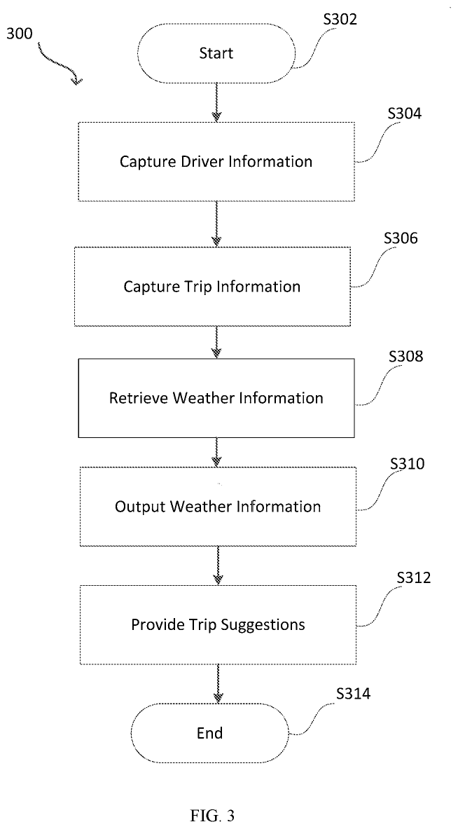

FIG. 3 is a flowchart outlining a second exemplary operation 300 for weather support in accordance with some embodiments of apparatus 100. The flowchart 300 starts with step 302 where the apparatus 100 for weather support detection is operated by the vehicle. At step 304, the camera 102 proactively captures user information when the user enters the vehicle. The vehicle can include one or more cameras 120 configured to capture visual data of the vehicle interior and/or the vehicle exterior. The camera 120 can be mounted on front, rear, top, sides, and interior of the vehicle depending on the technology requirement. The user information includes the trip supplies that the user prepares for the trip and the dress that the user wears. The camera 102 sends the user information to the processing device 114 via the interface device 112. The processing device 114 processes the user information captured by the camera 102 through signal processing, image processing, or video processing to identify the trip supplies that the user carries and the dress that the user wears. In another embodiment, the processing device 114 can apply the machine learning algorithm to identify the trip supplies that the user carries and the dress that the user wears. The machine learning algorithm is stored at the program database 122 and trained by the training device 116. The process to train and deploy the machine learning algorithm is shown in FIG. 4.

At step 306, the communication device 108 can proactively acquire the trip information of the user through the navigation system installed in the vehicle, the portable communication device of the user (e.g., a smartphone, or a tablet), or the request input via a microphone by the user. The trip information includes the expected location (e.g. a departure location, a transition location, and a destination) of the trip and the expected time (e.g. departure time, transition time, arrival time) of the trip. The communication device 108 further sends the trip information to the processing device 114 via the interface device 112. The processing device 114 subsequently analyzes the trip information captured by the communication device 108 to identify the expected location and the expected time of the trip. At step 308, the processing device 114 subsequently sends an instruction to the communication device 108 via the interface device 112 to retrieve the weather information according to the trip information. The communication device 108 retrieves the weather information through a weather website, an application, and/or a data store and sends the weather information to the processing device 114 via the interface device 112. At step 310, the processing device 114 outputs the weather information to the user through either the audio output device 106 (e.g., a speaker) or the display device 110 via the interface device 112.

At step 312 of the flowchart 300, the processing device 114 can further provide the trip suggestions based on the trip information, the weather information corresponding to the trip and the user information of the user. In an example, the processing device 114 recognizes that the destination of the trip has rain (steps 306 and 308) and the user does not have an umbrella (step 304). The processing device 114 can remind the user to bring an umbrella. In another example, when the user plans to drive to a beach that is captured by the processing device 114 at step 306, the apparatus 100 captures advisories related to the beach for poor water conditions at step 308. The processing device 114 can notify the user before leaving the vehicle so the user can decide whether to continue to the beach.

FIG. 4 is a schematic diagram illustrating an exemplary machine learning process 400. As shown in FIG. 4, 402 is a curated database that includes reference information associated with drivers, passengers, traffic conditions, and road conditions. For example, the curated database 402 can include reference user information, such as images of trip supplies (e.g., an umbrella, rain boots) that the user prepares for the trip or images of the dress (e.g., a heavy jacket, a pair of gloves) of the user, which are captured by the camera 102 from different users. In an exemplary embodiment, training 400, such as a standard supervised learning 400, can be implemented. While a supervised learning is described herein, it should not be considered limiting and is merely representative of a variety of approaches to object recognition. For example, an unsupervised learning or a deep learning can be applied as well. In the context of the present disclosure, the training 400 retrieves user information from the curated database 402 and a machine learning algorithm from program database 122. In an embodiment, the curated database 402 is a part of the training device 116. In another embodiment, the curated database 402 can be stored in the driving database 120 as shown in FIG. 1. The curated database 402 is actively maintained and updated via system software or via cloud-based system software updates. Feature learning 404 and target classification 406 are performed on the database 402 to portray the user information (e.g., an umbrella that the user prepares for the trip). Generally, feature learning 404 includes iterative convolution, activation via rectified linear units, and pooling, while classification 406 includes associating learned features with known labels (e.g., the umbrella). Learned features (e.g. images, signal parameters, patterns) may be manually selected or determined by the training 400. Upon the completion of the training 400, the machine learning algorithm can be applied for detecting the user information (e.g., an umbrella, rain boots) in a future event.

Following training 400, testing (not shown) of the machine learning algorithm is performed to ensure accuracy. Features are extracted from test user information (e.g., an umbrella, rain boots) and classified according to the training classifier 400. Following confirmation of the efficacy of the trained classifier, the training device 116 can deploy the trained machine learning algorithm to the processing device 114 for detecting the similar user information (e.g., an umbrella, rain boots) in a future event more accurately and promptly.

Still referring to FIG. 4, an operating 410 can be demonstrated based on machine learning results to catch the similar user information accurately and promptly in the future event. In an embodiment, the similar user information 412 (e.g. an umbrella) can be captured by the camera 102 in the future event from a different user. The processing device 114 can operate feature extraction 414 and target classification 416 through the machine learning algorithm that is trained and deployed by the training device 116. The processing device 114 can identify the user information (e.g., an umbrella) from the different user promptly and accurately through the machine learning operating 410 based on the images acquired by the camera 102.

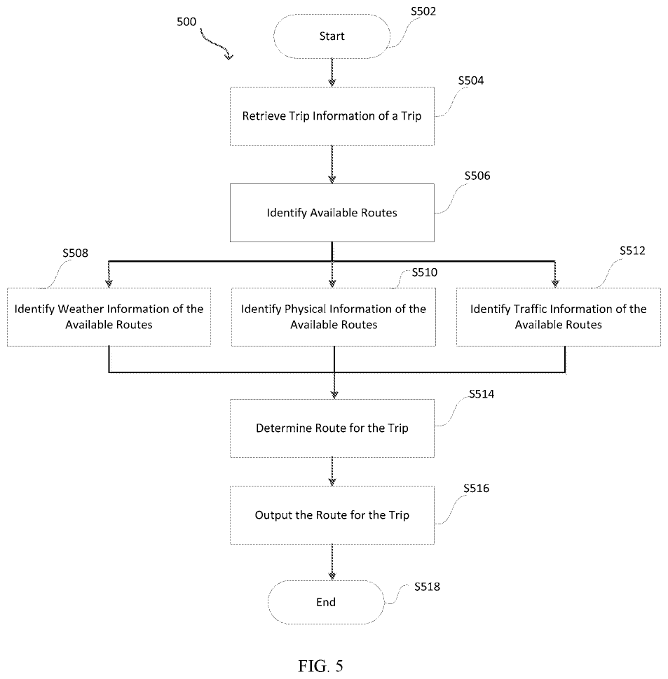

FIG. 5 is a flowchart outlining a third exemplary operation 500 for weather support, in accordance with some embodiments of apparatus 100. The flowchart 500 starts with step 502 where the apparatus 100 for weather support is operated by the vehicle. At step 504, the communication device 108 can proactively acquire trip information of the user through the navigation system installed in the vehicle, the portable communication device of the user, or the request input via a microphone by the user. The trip information includes an expected location (e.g. a departure location, a transition location, and a destination) of the trip and expected time (e.g. departure time, transition time, arrival time) of the trip. At step 504, the communication device 108 further sends the trip information to the processing device 114 via the interface device 112. The processing device 114 processes the trip information sent by the communication device 114 and identifies the departure location and the destination from the trip information.

At step 506, the processing device 114 further acquires available routes corresponding to the trip information from the map database 118. The available routes can include one or more routes connecting the departure location and the destination of the trip.

At step 508, the processing device 114 then retrieves respective weather information of each of the available routes through a weather website, an application, and/or a data store. The weather information disclosed herein can include rain, snow, ice, fog, heat, a flood, a tornado, a hurricane, an earthquake, a hail storm, a high wind, or the like.

At step 510, the processing device 114 retrieves respective physical information of each of the available routes through a vehicle to infrastructure system, a cloud-based system, an application, and/or a data store. The physical information of the routes includes a road repair, total lanes, road surface conditions, an on-ramp, an off-ramp, an incline, a decline, a curve, a straightaway, a pothole, or the like.

At step 512, the processing device 114 retrieves respective traffic information of each of the available routes through a traffic system, a cloud-based system, an application, and/or a data store. The traffic information of the routes includes traffic congestion, a stop sign, a speed limit, traffic lights, or the like.

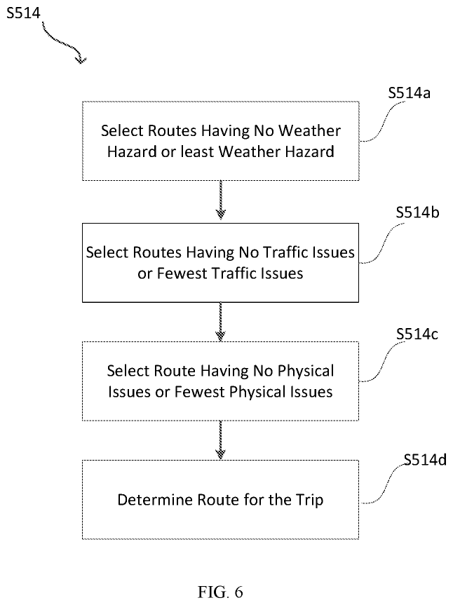

The flowchart 500 then proceeds to step 514. At step 514, once the weather information, the traffic information, and the physical information of the available routes are collected, the processing device 114 starts to determine route for the trip. The details of the step 514 are illustrated at FIG. 6. As shown in FIG. 6, the step 514 starts with sub step 514a. At sub step 514a, the processing device 114 firstly selects routes having no weather hazard from the available routes based on the respective weather information of each of the available routes. If no route is free of weather hazard, the processing device selects routes with least weather hazard. For example, the processing device can select a route having minimum precipitation level in an area with thunderstorm. The weather hazards disclosed herein include snow, heavy wind, a hurricane, an earthquake, heavy rain, thunderstorm, or the like. The step 514 then proceeds to sub step 514b, where the processing device 114 selects routes having no traffic issues or fewest traffic issues from the routes that have no weather hazard or least weather hazard based on the respective traffic information of each of the available routes. The traffic issues include traffic congestion, traffic accidents, traffic controls, or the like.

The step 514 further proceeds to sub step 514c. At sub step 514c, the processing device 114 selects routes having no physical issues or fewest physical issues from the routes that have no traffic issues or least traffic issues based on the respective physical information of each of the available routes. The physical issues of the routes include rough road surface, potholes, road repairs, or the like. At sub step 514d, the processing device 114 determines route for the trip from the routes that has no physical issues or fewest physical issues based on criteria, such as total driving time, driving costs, or driving distance. For example, the processing device 114 can choose a route with minimum total driving time.

It should be noted that, in some embodiments, the step 514 can skip sub step 514b, skip sub step 514c, or skip both sub step 514b and 514c based on the requirement of the user.

Still referring to FIG. 5, the flowchart 500 then proceeds to step 516. At step 516, the processing device 114 can output the determined route for the trip to the display device 110. In another embodiment, the processing device 114 can further provide a hazard warning to the user via the speaker 106 or the display device 110. In yet another embodiment, the processing device can output route with minimum driving time, route with least driving cost, and route with smallest driving distance through the display device 110 to the user. The user can make a choice through the display device 110. In yet another embodiment, the processing device 114 can output the determined route to the navigation system and the vehicle follows the determined route via the navigation system.

According to an aspect of the operation 500, the apparatus 100 can determine a route based on current or expected weather. For instance, the apparatus 100 can use flash floods predictive mapping acquired by the communication device 108 to avoid a route that is known to flood. The apparatus 100 can prioritize raised roads during floods, such as by using a topographic map acquired by the communication device 108.

According to another aspect of the operation 500, during heavy downpours, the apparatus 100 can prioritize covered routes over non-covered routes based on the acquired weather information and traffic information. The apparatus 100 can prioritize routes based on lighting provided by the moon with lighted routes given a higher priority over non-lighted routes based on the acquired traffic information.

According to another aspect of the operation 500, the apparatus 100 can track the location of tornados, hurricanes, and other destructive weather phenomenon based on the acquired weather information at step 508, and the apparatus 100 can route the vehicle based on such information and/or provides warnings to the user (e.g., a driver, a passenger).

According to another aspect of the operation 500, the apparatus 100 can also track hail storms, high winds, and other weather hazard based on the acquired weather information. When the vehicle is parked outside with such condition expected, then the apparatus 100 can warn the user that the poor weather is expected and the vehicle is not covered.

According to another aspect of the operation 500, during a hurricane, the apparatus 100 can prioritize evacuation routes. The apparatus 100 can also enable a user to ask whether a particular location is safe for an upcoming weather pattern.

According to yet another aspect of the apparatus 500, when the vehicle is operating autonomously, the apparatus 100 can take into account the current or expected weather to select an appropriate parking location.

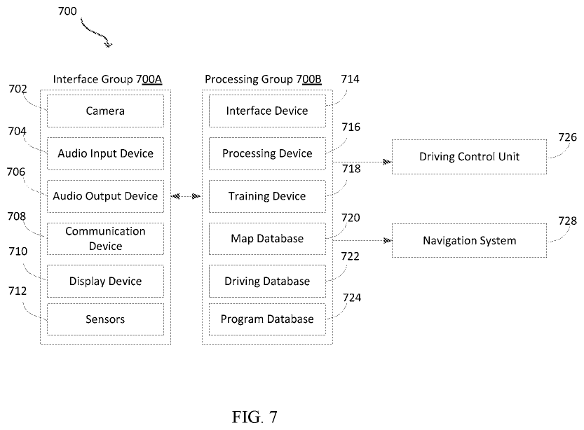

FIG. 7 illustrates another exemplary apparatus 700 for weather support. Comparing to the apparatus 100, the interface group 700A has a plurality of sensors 712. The sensors 712 can include a radar sensor, a LIDAR senor, a sonar sensor, an IMU sensor, motion sensors, or the like. The sensors 712 can detect the traffic information that the vehicle encounters during driving. The vehicle can drive automatically based on the traffic information that is detected by the sensors 712. In addition, comparing to the apparatus 100, the processing group 700B can include a driving control unit 726 and a navigation system 728. The driving control unit 726 can be electro-mechanical equipment to guild the vehicle to take full autonomous driving. In an example, the driving control unit 726 can be integrated into or be a part of an anti-lock braking system (ABS) in the vehicle. In another example, the driving control unit 726 can be integrated into or be a part of advanced driver-assistance system (ADAS) in the vehicle.

An exemplary operation of the apparatus 700 can still be illustrated in FIG. 5. For example, at step 516 of FIG. 5, the processing device 716 outputs the determined route for the trip to the navigation system 728 of the apparatus 700. The driving control unit 726 of the apparatus 700 can automatically control driving of the vehicle according to the determined route that is output to the navigation system 728.

In the present disclosure, a novel method and an apparatus for expanded weather support associated with a vehicle are provided. The apparatus has an interface group and a processing group. The interface group includes a camera configured to capture the driver information, an audio input device configured to receive the request from the user to check the weather information, an audio output device configured to output the weather information or the trip suggestions provided by the processing group, a communication device configured to retrieve weather information/traffic information/physical information of a route and trip information of a trip, and a display device configured to output the weather information or the trip suggestions provided by the processing group. The processing group includes an interface device configured to transmit the messages within the apparatus and between the apparatus and the external devices, a training device configured to train a machine learning algorithm, a processing device configured to implement various functions of the apparatus, a map database to provide the route information, a driving database to provide reference information associated with drivers, passengers, traffic conditions, and road conditions and a program database to store programs that are executable by the processing device to implement the various functions of the apparatus.

In the present disclosure, the method and the apparatus provide expanded weather support to the user of the vehicle and enhance interaction between the user and the vehicle. In an embodiment, the method and the apparatus can passively receive the request from the user to check the weather information and provide the weather information according to the expected location and the expected time provided by the request. The method and the apparatus can further provide trip suggestions according to the weather information to the user. In another embodiment, the method and the apparatus can also proactively capture the user information and trip information of the user. The user information includes the trip supplies that the user prepares for the trip and the dress that the user wears. The method and the apparatus proactively retrieve the weather information associated with the trip information and provide the weather information and trip suggestions to the user. The trip suggestions can be suggestions on the trip supplies and trip safety. In yet another embodiment, the method and the apparatus can further provide route selections based on the weather information and the trip information so as to avoid weather hazards. The method and the apparatus can implement machine learning to improve the interaction between the user and the vehicle.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

What is claimed is:

1. A method for weather support, comprising:
receiving, via interface circuitry of an apparatus installed in a vehicle, a request to check weather information;
identifying, by processing circuitry of the apparatus, an expected location and expected time of a trip provided by the request, retrieving the weather information corresponding to the trip, and outputting the weather information and trip suggestions in response to the request;
capturing, via the interface circuitry, user information and trip information of the trip, retrieving the weather information corresponding to the trip, outputting the weather information corresponding to the trip, and providing trip suggestions to the user according to the user information, the trip information and the weather information; and
retrieving, via the interface circuitry, the trip information of the trip, identifying a plurality of available routes associated with the trip, retrieving respective weather information of each of the plurality of available routes, retrieving respective physical information of each of the plurality of available routes, retrieving respective traffic information of each of the plurality of available routes, determining a route for the trip based on the respective weather information, the respective physical information and the respective traffic information of each of the plurality of available routes, and outputting the determined route for the trip.

2. The method of claim 1, further comprising:
receiving the request from the user through a microphone;
identifying the expected location and the expected time of the trip provided by the request through a voice recognition technique;
retrieving the weather information corresponding to the trip through at least one of a weather website, an application, and a data sore;
outputting the weather information in response to the request through a speaker or a display device;
providing the trip suggestions according to the weather information through the speaker or the display device.

3. The method of claim 2, wherein the retrieving the weather information corresponding to the trip comprises:
retrieving weather information on a specific day or at specific time;
retrieving weather information for a duration of days or a period of time;
retrieving weather information for a specific location; and
retrieving current weather information at current location.

4. The method of claim 2, wherein the providing the trip suggestions comprises:
providing suggestions on trip supplies; and
providing suggestions on trip safety.

5. The method of claim 1, further comprising:
capturing the user information of the user through a camera, the user information including trip supplies that the user prepares for the trip and dress that the user wears;
capturing the trip information through at least one of a navigation system installed in the vehicle, a portable communication device of the user, and the request input via a microphone by the user, the trip information including the expected location and the expected time of the trip;
retrieving the weather information corresponding to the trip through at least one of a weather web site, an application, and a data store;
outputting the weather information corresponding to the trip through a speaker or a display device; and
providing the trip suggestions to the user on the trip supplies and trip safety through the speaker or the display device according to the captured user information, the captured trip information and the retrieved weather information.

6. The method of claim 5, wherein the capturing the user information of the user is operated through at least one of image recognition, pattern recognition, feature recognition, and signal recognition.

7. The method of claim 5, further comprising:
training a machine learning algorithm based on the captured user information, and deploying the trained machine learning algorithm to identify similar user information in a future event.

8. The method of claim 1, further comprising:
retrieving the trip information of the trip through at least one of a navigation system installed in the vehicle, a portable communication device of the user, and the request input via a microphone by the user;
identifying the plurality of available routes associated with the trip through a map database;
retrieving the respective weather information of each of the plurality of available routes through at least one of a weather website, an application, and/or a data store;
retrieving the respective physical information of each of the plurality of available routes through at least one of a vehicle to infrastructure system, a cloud-based system, an application, and/or a data store;
retrieving the respective traffic information of each of the plurality of available routes through at least one of a traffic system, a cloud-based system, an application, and a data store;
determining the route for the trip from the available routes based on the respective weather information, the respective physical information and the respective traffic information of each of the plurality of available routes; and
outputting the route for the trip to at least one of a speaker, a display device, and a navigation system.

9. The method of claim 8, wherein the determining the route for the trip based on the respective weather information, the respective physical information and the respective traffic information of each of the available routes comprising:
selecting routes having no weather hazard or least weather hazard from the plurality of available routes based on the respective weather information of each of the plurality of available routes;
selecting routes having no traffic issues or fewest traffic issues from the routes that have no weather hazard or least weather hazards based on the respective traffic information of each of the plurality of available routes;
selecting routes having no physical issues or fewest physical issues from the routes that have no traffic issues or fewest traffic issues based on the respective physical information of each of the plurality of available routes; and
determining the route for the trip from the routes that has no physical issues or the fewest physical issues based on at least one of total driving time, driving costs, or driving distance.

10. The method of claim 8, further comprising:
outputting the determined route for the trip to the navigation system and automatically controlling driving of the vehicle through a control unit according to the determined route that is output to the navigation system.

11. An apparatus for weather support, comprising:
interface circuitry configured to transmit messages within the apparatus, and between the apparatus and external devices; and
processing circuitry configured to
receive, via the interface circuitry, a request from a user to check weather information, identify an expected location and expected time of a trip provided by the request, retrieve the weather information corresponding to the trip, and output the weather information and trip suggestions in response to the request;
capture, via the interface circuitry, user information and trip information of the trip, retrieve the weather information corresponding to the trip, output the weather information corresponding to the trip, and provide trip suggestions to the user according to the user information, the trip information and the weather information; and
retrieve, via interface circuitry, the trip information of the trip, identify a plurality of available routes associated with the trip, retrieve respective weather information of each of the plurality of available routes, retrieve respective physical information of each of the plurality of available routes, retrieve respective traffic information of each of the plurality of available routes, determine a route for the trip based on the respective weather information, the respective physical information and the respective traffic information of each of the plurality of available routes, and output the determined route for the trip.

12. The apparatus of claim 11, wherein the processing circuitry is further configured to:
receive the request from the user through a microphone;
identify the expected location and the expected time of the trip provided by the request through a voice recognition technique;
retrieve the weather information corresponding to the trip through at least one of a weather web site, an application, and/or a data sore;
output the weather information in response to the request through a speaker or a display device;
provide the trip suggestions according to the weather information through the speaker or the display device.

13. The apparatus of claim 12, wherein the processing circuitry is further configured to:
retrieve the weather information on a specific day or at specific time;
retrieve the weather information for a duration of days or a period of time;
retrieve the weather information for a specific location; and
retrieve current weather information at a current location.

14. The apparatus of claim 12, wherein the processing circuitry is further configured to:
provide suggestions on trip supplies; and
provide suggestions on trip safety.

15. The apparatus of claim 11, wherein the processing circuitry is further configured to:
capture the user information of the user through a camera, the user information including trip supplies that the user prepares for the trip and dress that the user wears;
capture the trip information through at least one of a navigation system installed in the vehicle, a portable communication device of the user, or the request input via a microphone by the user, the trip information including the expected location and the expected time of the trip;
retrieve the weather information corresponding to the trip through at least one of a weather web site, an application, and a data store;
output the weather information corresponding to the trip through a speaker or a display device; and
provide the trip suggestions to the user on the trip supplies and trip safety through the speaker or the display device according to the captured user information, the captured trip information and the retrieved weather information.

16. The apparatus of claim 15, wherein the processing circuitry is further configured to
train a machine learning algorithm based on the captured user information, and deploy the trained machine learning algorithm to identify similar user information in a future event.

17. The apparatus of claim 11, wherein the processing circuitry is further configured to
retrieve the trip information of the trip through at least one of a navigation system installed in the vehicle, a portable communication device of the user, or the request input via a microphone by the user;
identify the plurality of available routes associated with the trip through a map database;
retrieve the respective weather information of each of the plurality of available routes through at least one of a weather web site, an application, and a data store;
retrieve the respective physical information of each of the plurality of available routes through at least one of a vehicle to infrastructure system, a cloud-based system, an application, and a data store;
retrieve the respective traffic information of each of the plurality of available routes through at least one of a traffic system, a cloud-based system, an application, and a data store;
determine the route for the trip from the plurality of available routes based on the respective weather information, the respective physical information and the respective traffic information of each of the available routes; and
output the route for the trip to at least one of a speaker, a display device, and a navigation system.

18. The apparatus of claim 17, wherein the processing circuitry is further configured to:
select routes having no weather hazard or least weather hazards from the plurality of available routes based on the respective weather information of each of the plurality of available routes;
select routes having no traffic issues or fewest traffic issues from the routes that have no weather hazard or least weather hazards based on the respective traffic information of each of the plurality of available routes;
select routes having no physical issues or fewest physical issues from the routes that have no traffic issues or fewest traffic issues based on the respective physical information of each of the plurality of available routes; and
determine the route for the trip from the routes that has no physical issues or fewest physical issues based on at least one of total driving time, driving costs, or driving distance.

19. The apparatus of claim 17, wherein the processing circuitry is further configured to:
output the determined route for the trip to the navigation system and automatically control driving of the vehicle through a control unit according to the determined route that is output to the navigation system.

20. A non-transitory computer readable storage medium having instructions stored thereon that when executed by processing circuitry causes the processing circuitry to perform operations, the operations comprising:
receiving a request from a user to check weather information, identifying an expected location and expected time of a trip provided by the request, retrieving the weather information corresponding to the trip, and outputting the weather information and trip suggestions in response to the request;
capturing user information of the user and trip information of the trip, retrieving the weather information corresponding to the trip, outputting the weather information corresponding to the trip, and providing trip suggestions to the user according to the user information, the trip information and the weather information; and
retrieving the trip information of the trip, identifying a plurality of available routes associated with the trip, retrieving respective weather information of each of the plurality of available routes, retrieving respective physical information of each of the plurality of available routes, retrieving respective traffic information of each of the plurality of available routes, determining a route for the trip based on the respective weather information, the respective physical information and the respective traffic information of each of the plurality of available routes, and outputting the determined route for the trip.
